(19) United States
(12) Patent Application Publication
(10) Pub. No.: US 2025/0189346 A1
(43) Pub. Date: Jun. 12, 2025

(54) METHOD FOR DETERMINING A REPEATABILITY VARIANCE

(71) Applicant: Robert Bosch GmbH, Stuttgart (DE)

(72) Inventors: Stefan Muelders, Muenchingen (DE); Clemens Majer, Ingersheim (DE)

(21) Appl. No.: 18/845,976

(22) PCT Filed: Feb. 2, 2023
(86) PCT No.: PCT/EP2023/052560

§ 371 Date: Sep. 11, 2024

(30) Foreign Application Priority Data
Mar. 22, 2022 (DE) 10 2022 202 795.7

(51) Int. Cl. G01D 1/14

(52) U.S. Cl. CPC G01D 1/14

(57) ABSTRACT

A method (1000) for determining the repeatability variance of a given measurement process to be carried out on a test object (1), comprising the following steps:
providing (100) at least one test object (1);
determining (200) at least one measurement parameter (2) of the measurement process, on which measurement parameter the result of the measurement process also depends, in addition to the properties of the test object (1), which properties are to be measured and are provided in the form of a measurement variable (3) to be considered;
determining a variation range (21) for the at least one measurement parameter (2);
carrying out (300) a plurality of measurements on the test object (1) for various values (210, 211, 212) of the at least one measurement parameter (2) within the relevant variation range (21), so that at least one distribution (310, 311, 312) of the measured values of the measurement variable (3) is obtained with at least one measure of dispersion (310a, 311, 312a), in particular a dispersion range;
analyzing the sought-after repeatability variance from the at least one measure of dispersion (310a, 311a, 312a) of the at least one distribution (310, 311, 312) of the measured values obtained.

### BACKGROUND

The present invention relates to a method for determining a repeatability variance. The invention also relates to a computer program implementing the aforementioned method, a machine-readable data carrier with such a computer program, and one or a plurality of computers comprising the aforementioned computer program.

Statistical methods are used to verify the measurement process capability as part of the functional testing of series components, which are based, among other things, on the determination of the repeatability variance of a test characteristic. Among other things, the % GRR method has proven very successful in this context. Typically, a repeatability variance is considered for the measurement process evaluation, which usually includes the measurement of a larger number of test objects. For example, 25 test objects can be measured at least twice each. A dispersion range is determined for the measured values obtained on each test object. The dispersion ranges obtained for all test objects form a distribution whose standard deviation is determined. Finally, a capability of the measurement process is derived or evaluated from this standard deviation. For example, the measurement process can be deemed suitable if the ratio of the repeatability variance to the tolerance for the tested characteristic falls below a predefined threshold value. Such measurements are often carried out by a plurality of inspectors and also require the provision of a sufficiently large number of test objects for a statistically accessible analysis.

### SUMMARY

It was recognized that a test process evaluation according to conventional methods is not feasible in the case of very few test objects. This means that measurement processes involving small series of test objects or measurement processes at an early stage of development cannot be considered in conventional test process evaluation methods.

The present invention relates to a method for determining the repeatability variance of a given measurement process which is to be carried out on at least one test object. The method comprises at least the steps described below.

Repeatability variance refers to the scattering of the measured values when the measurement is repeated on the same object, in the same laboratory, by the same personnel (repeat conditions). Here, the measurement parameters can be kept constant between the measurements in a first measurement process and varied in a second measurement process under otherwise identical conditions. Here, “keep constant” or “vary” can refer to the selection of the measurement parameters and/or the values of these measurement parameters. In the following, the selection of measurement parameters is kept constant, but the values of the measurement parameters are varied.

In one method step, at least one test object is provided. Furthermore, in the next step, at least one measurement parameter of the measurement process is determined, on which the result of the measurement process also depends-in addition to the properties of the test object to be measured, which can be described by a measurement variable to be considered. In a further step, a variation range for the at least one measurement parameter is determined in order to then carry out a plurality of measurements on the test object, wherein various values of the at least one measurement parameter are to be selected within the determined respective variation range, so that a measured value of the measurement variable under consideration is obtained in each case in the course of a measurement.

Repeated measurements are then used to determine a plurality of measured values with each selected measurement parameter, which form at least one separate distribution with at least one measure of dispersion, in particular a dispersion range. Finally, the sought-after repeatability variance is analyzed from the measures of dispersion.

This can be done, for example, with a statistical analysis of the distributions obtained by determining a standard deviation over all measures of dispersion obtained and then analyzing the sought-after repeatability variance of the measurement process from this standard deviation.

The repeatability variance can, for example, correspond to the standard deviation over the at least one measure of dispersion, in particular over all dispersion ranges obtained. However, the repeatability variance can also be determined, for example, as the difference between the maximum of the dispersion ranges obtained and the minimum of the dispersion ranges obtained.

It should be noted that the measurement parameter, which is varied in the method described above and in the following, is not varied in a conventional method for evaluating the measurement process capability, but is kept constant.

A plurality of measurement parameters of the measurement process can also be determined, on which the result of the measurement process depends in addition to the properties of the test object to be measured, given by a measurement variable to be considered. A variation range is then determined for each measurement parameter. Furthermore, a plurality of measurements can then be carried out on the test object for various values of each measurement parameter within the respective variation range, so that a plurality of distributions of measured values of the measurement variable under consideration are obtained, each with a measure of dispersion, in particular a dispersion range. The sought-after repeatability variance can then be analyzed from the measures of dispersion of the distributions of the measured values obtained.

The method described above and in the following makes it possible to evaluate a measurement process, i.e., to assess its measurement process capability, when only a small number of test objects are available. The method can therefore also be used to determine whether a measurement process is sufficiently qualified for a small number of test objects, right down to a single test object. The method is therefore suitable for evaluating a measurement process when there is only one test object or a small number of test objects. A measurement uncertainty of a measurement method under consideration can be examined, wherein, for example, resources in the form of stable parts, which must be provided and possibly also selected for a capability test, can be reduced or saved. This can lead to considerable potential savings in terms of costs for series parts and in terms of set-up times in corresponding test facilities.

A further advantage of the method described above and in the following is that the capability test in relation to the measurement process can be carried out with one test object or a small number of test objects at an early stage of a corresponding development process in which only a few sample test objects are available. This makes it possible to demonstrate the capability of the measurement process at an early stage of the project. In particular, any potential improvements can be identified and implemented at such an early stage. This in turn can lead to a considerable savings potential compared to the case of a later proof of capability, in the course of which the need for substantial changes or improvement of the measurement process could only be recognized after high costs have already been incurred.

According to an exemplary embodiment, the variation range for the measurement parameter is determined on the basis of a target value. In addition or instead, the variation range for the measurement parameter can be defined using a predefined fluctuation range for the measurement variable in conjunction with a known correlation between the measurement variable and the measurement parameter.

The known correlation between the measurement variable and the measurement parameter can be, for example, a characteristic curve that describes the dependency of the measurement variable on the measurement parameter. A functional correlation between the measurement variable and the measurement parameter can be known in the form of a formula, by which, for example, a characteristic curve can be obtained by inserting at least corresponding values for the measurement parameter and possibly other parameters characterizing the measurement process and/or the test object. It is also possible that a functional correlation has been additionally or exclusively determined experimentally and stored, for example, in the form of a table of values, from which representative corresponding values for the measurement parameter and the measurement variable can be taken, for example. A table of values or a corresponding graphical application of a correlation between the measurement variable and the measurement parameter, possibly with suitable interpolation, can be stored in digital form and/or in the form of a data sheet. The target value of the measurement variable and the variation range of the measurement parameter can also be stored in digital or analog form in a data sheet.

For example, the measurement parameter can be varied in steps as part of the method, wherein the step size of the variation in the subsequent step are adjusted in each case as a function of the distance between the distribution of measured values obtained in the previous step and/or the median or mean value of this distribution and the predefined target value of the measurement variable.

This can be achieved, for example, by looking at the amount of the difference between the distribution of measured values, or the median or mean value, on the one hand and the target value of the measurement variable on the other. For measured values in the vicinity of the target value, for example, a smaller step size can be selected when varying the measurement parameter in order to achieve a more accurate consideration of this range of the measurement variable. This allows a range around the target value that is particularly relevant for the measurement process to be given greater consideration.

Furthermore, it may be provided that the step width with which the measurement parameter is varied is selected to be smaller in a range around the target value of the measurement variable and larger in the vicinity of an upper and lower limit of the fluctuation range for the measurement variable. This means that areas of the measured values that lie at a greater distance from the target value of the measurement variable can play a weaker role in the examination of the capability verification of the measurement process, and areas that lie in the vicinity of the target value of the measurement variable are given a stronger weighting in the capability verification.

According to a further exemplary embodiment, the variation range for the measurement parameter is determined on the basis of a technical specification of the measurement process, a device used for the measurement process, and/or the test object. In this way, corresponding prior knowledge can be used to determine the repeatability variance.

According to a further exemplary embodiment, the target value of the measurement variable, the fluctuation range of the measurement variable, the known correlation between the measurement variable, and the measurement parameter and/or the technical specification is obtained from at least one data sheet. Additionally or alternatively, the aforementioned variables can be obtained from a digitally stored data set of the measurement process, a device used for the measurement process, and/or the test object. These sources of prior knowledge can then also be used for the method for determining the repeatability variance.

According to an exemplary embodiment, at least one specimen of a component manufactured as a single piece or in series can be selected as the test object. Advantageously, a small number of manufactured test objects can be used in the course of the method, for example only one or two test objects. This reduces the costs associated with providing the test objects and carrying out the measurement process. Furthermore, the method can also be used to evaluate a measuring process in which small series with a small number of series components are present. At least one part of such a small series can thus be used as a test object within the scope of the method, and a corresponding provision of a larger number of test objects of the small series can be avoided.

According to one exemplary embodiment of the invention, a fuel injector for an internal combustion engine can be selected as the test object. The provision of a larger number of fuel injectors in order to determine a repeatability variance of a corresponding measurement process as part of a test process evaluation is no longer necessary in the method described above and in the following.

According to one exemplary embodiment, it is possible to determine whether the repeatability variance determined as part of the method fulfills a predefined criterion. If this is the case, the measuring process can be declared suitable for the quality control of series production.

For example, the predefined criterion may be the condition that a ratio of the determined repeatability variance and a predefined tolerance does not exceed or, depending on the formulation of the condition, fall below a predefined value. A version of a % GRR capability verification adapted to the method described here can be used.

According to an exemplary embodiment, the measurement variable can comprise an injection quantity of a liquid, a supply quantity of a gas, an output power, a current, and/or a torque.

According to a further exemplary embodiment, the measurement parameter can comprise a pressure, an injection time, an electrical voltage, and/or a temperature.

Further, the invention relates to a computer program comprising machine-readable instructions which, when executed on one or a plurality of computers, cause the computer or computers to perform a method according to the invention. The invention also comprises a machine-readable data carrier on which the aforementioned computer program is stored, and a computer equipped with the aforementioned computer program or the aforementioned machine-readable data carriers.

### BRIEF DESCRIPTION OF THE DRAWINGS

Further measures improving the invention are described in greater detail hereinafter, together with the description of the preferred exemplary embodiments of the invention, with reference to the drawings.

The following is shown in the figures:

FIG. 1 an exemplary embodiment of the method 1000 for determining the repeatability variance of a given measurement process to be carried out on a test object 1;

FIG. 2 another exemplary embodiment of the method 1000.

### DETAILED DESCRIPTION

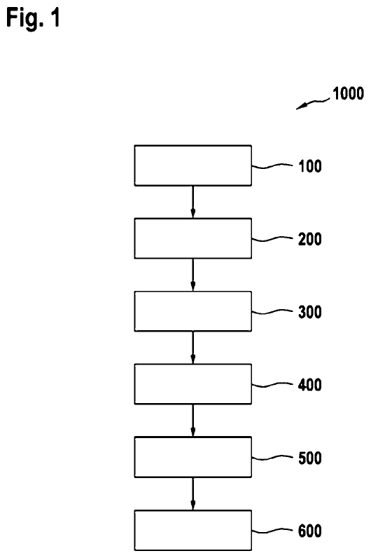

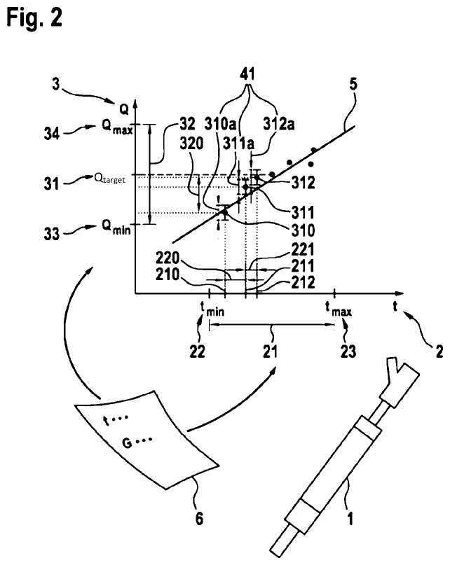

According to FIG. 1, the method comprises at least the steps described below. In step 100, at least one test object 1 is provided. The test object 1 can be a fuel injector, for example. In step 200, at least one measurement parameter 2 of the measurement process is determined, on which the result of the measurement process depends in addition to the properties of the test object 1 to be measured. The properties of the test object 1 to be measured relate to a measurement variable 3 to be considered as part of the measurement process. It should be noted that in conventional methods for determining the repeatability variance of a measurement process, the aforementioned measurement parameter is not subject to variation but is selected as a constant. In a further step 300, a variation range 21 for the measurement parameter 2 is determined. Then, in step 400, a plurality of measurements are carried out on the test object 1, wherein the measurement parameter 2 is changed within the determined variation range 21 and a plurality of measured values (at least 2) of the measurement variable under consideration are obtained for corresponding values of the measurement parameter. In step 500, a dispersion range 310a, 311a, 312a is calculated from the distribution 310, 311, 312 of the obtained measured values of the measurement variable for each measurement parameter variation carried out. Finally, in step 600, the sought-after repeatability variance of the measurement process is determined at least from the standard deviation 41 of the individual dispersion ranges 310a, 311a, 312a. The correlations between all the variables mentioned are explained in detail below using FIG. 2.

FIG. 2 shows an exemplary realization of method 1000 in the series production of fuel injectors. A fuel injector is provided as test object 1, on which a measurement process is to be carried out and in the context of which the repeatability variance of the measurement process is to be determined. One aim of the method 1000 is to determine whether the repeatability variance fulfills a predefined criterion, wherein if the criterion is fulfilled, the measurement process can be declared suitable for quality control of series production.

A measurement parameter 2 of the measurement process is also determined. This is a parameter that is not varied in conventional methods for determining the repeatability variance as part of the associated measurements. A difference between the method described here and conventional methods with the aim of evaluating the measurement process lies in particular in the fact that in the former a parameter variation is carried out as part of the generation of measured values, whereas in the latter a large number of test objects are used in the course of generating corresponding measurement data and the measurement parameter assumes a predefined fixed value. The result of the measurement process obviously depends, among other things, on the choice of measurement parameter 2. In the example shown in FIG. 2, an activation time t of the fuel injector is selected as measurement parameter 2.

In the method described here, a variation range 21 for the measurement parameter 2 is therefore determined, and a plurality of measurements are carried out on the test object 1 with different values 210, 211, 212 within the variation range 21 of the measurement parameter 2. Here, the activation time t varies between a minimum time tₘᵢₙ as the lower limit 22 of the variation range 21 and a maximum time tₘₐₓ as the upper limit 23 of the variation range 21.

As outlined in FIG. 2, it is possible to determine the variation range 21 of the measurement parameter 2, which can be described by an upper limit 23 and a lower limit 22, using a target value 31 of the measurement variable 3 and an associated fluctuation range 32 of the measurement variable 3. The upper limit 23 of the variation range 21 of the measurement parameter 2, in this case the maximum activation time tₘₐₓ, can therefore correspond, for example, to an upper limit 34 of the fluctuation range 32 of the measurement variable 3, in this case the maximum injection quantity Qₘₐₓ. Similarly, the lower limit 22 of the variation range 21 of the measurement parameter 2, in this case the minimum actuation time tₘᵢₙ, can correspond to a lower limit 33 of the fluctuation range 32 of the measurement variable 3, in this case the minimum injection quantity Qₘᵢₙ. Alternatively or additionally, a known correlation 5 between the measurement variable 3 and the measurement parameter 2 that is valid in the variation range 21 of the measurement parameter 2 can also be used. The correlation 5 can, for example, be a known characteristic curve 5 between measurement variable 3 and measurement parameter 1, which can be tabulated or recorded in graphical form. A corresponding table, but also a graphical representation of the correlation between measurement variable 3 and measurement parameter 2, can, for example, be obtained by interpolation using previous measurements on one or a plurality of reference test object(s) and used as part of the method described here. The corresponding information relating to the characteristic curve 5 can be stored in digital or analog form in a database or a data sheet 6 and used in the corresponding method step.

A plurality of measurements are now carried out on the test object 1, wherein different values 210, 211, 212 of the measurement parameter 2 within the variation range 21 are considered. For each value 210, 211, 212 of the measurement parameter 2, a distribution 310, 311, 312 of measured values with a dispersion range 310a, 311a, 312a is obtained. The points (symbol○) shown in FIG. 2 indicate the mean values of the distributions 310, 311, 312 and other similar distributions. These mean values scatter around the characteristic curve 5.

As part of the measurement process, the measurement parameter 2 can be varied step by step. It is possible that the step width 220, 221 between successive measurements is adapted in each case as a function of the distance that the distribution 310, or also for example a median or mean value over this distribution 310, has from the target value 31 of the measurement variable 3. For example, the step size 221 in a subsequent step may be selected to be smaller than the step size 220 in a previous step if the distribution 310, or its mean or median, in the previous step has a small distance 320 from the predefined target value 31 of the measurement variable 3. A small distance can, for example, be understood as a deviation in amount within a predefined limit. As a result, within the framework of this method, a larger number of measured values can be generated in the vicinity of the target value 31 of the measurement variable 3 than in areas in which the measured value is at a greater distance 320 from the target value 31. In addition and in an analogous manner, the step size 220 of a subsequent step can be selected to be larger compared to a step size 221 of a previous step if the distribution 310, or its mean or median, should have a larger distance 320 from the predefined target value 31 of the measurement variable 3 in the previous step.

It is also possible that the variation range 21 and possibly also the parameter values to be selected for the measurement parameter 2 are determined by a technical specification of the measurement process, a device used for the measurement process, and/or the test object 3. Corresponding data and specifications can be taken in particular from an analog or digital data set or data sheet 6. This also applies to the target value 31 of the measurement variable 3, the fluctuation range 32, and the known correlation 5.

Using the dispersion ranges 310a, 311a, 312a of the distributions 310, 311, 312 of the measured values obtained, which each represent injection quantities Q, a standard deviation 41, σQ is finally determined as the sought-after repeatability variance. Alternatively, the sought-after repeatability variance can also be determined from the difference between the maximum and minimum of all dispersion ranges. Finally, a standardized criterion can be used to check whether the measurement process can be considered suitable for quality control in series production.

1. A method (1000) for determining the repeatability variance of a measurement process to be carried out on a test object (1), comprising the following steps:
providing (100) at least one test object (1);
determining (200), via a computer, at least one measurement parameter (2) of the measurement process, on which measurement parameter the result of the measurement process also depends, in addition to the properties of the test object (1), which properties are to be measured and are provided in the form of a measurement variable (3) to be considered;
determining a variation range (21), via the computer, for the at least one measurement parameter (2);
carrying out (300), via the computer, a plurality of measurements on the test object (1) for various values (210, 211, 212) of the at least one measurement parameter (2) within the relevant variation range (21), so that at least one distribution (310, 311, 312) of the measured values of the measurement variable (3) is obtained with at least one measure of dispersion (310a, 311a, 312a); and
analyzing, via the computer, the sought-after repeatability variance from the at least one measure of dispersion (310a, 311a, 312a) of the at least one distribution (310, 311, 312) of the measured values obtained.

2. The method (1000) according to claim 1, wherein the following steps are carried out:
providing (100) at least one test object (1);
determining (200) a plurality of measurement parameters (2) of the measurement process, on which the result of the measurement process depends in addition to the properties of the test object (1) to be measured, given by a measurement variable (3) to be considered;
determining a variation range (21) for each measurement parameter (2);
carrying out (300) a plurality of measurements on the test object (1) for various values (210, 211, 212) of each measurement parameter (2) within the respective variation range (21), so that a plurality of distributions (310, 311, 312) of measured values of the measurement variable (3) are obtained, each with a measure of dispersion (310a, 311a, 312a);
1 analyzing the sought-after repeatability variance from the measures of dispersion (310a, 311a, 312a) of the distributions (310, 311, 312) of the measured values obtained.

3. The method (1000) according to claim 1, wherein a standard deviation (41) over the at least one measure of dispersion (310a, 311a, 312a) is determined as the sought-after repeatability variance.

4. The method according to claim 1, wherein the sought-after repeatability variance is determined as the difference between the maximum and the minimum of all dispersion ranges.

5. The method (1000) according to claim 1, wherein the variation range (21) for the measurement parameter (2) is determined on the basis of a target value (31) and/or a predefined fluctuation range (32) for the measurement variable (3) in conjunction with a known correlation (5) between the measurement variable (3) and the measurement parameter (2).

6. The method (1000) according to claim 5, wherein the measurement parameter (2) is varied in steps, and the step size (220, 221) is adapted in the subsequent step in each case as a function of the distance (320) of the distribution (310) of measured values obtained in the preceding step, and/or of their median or mean value, to the predefined target value (31) of the measurement variable (3).

7. The method (1000) according to claim 6, wherein the step width (220, 221), with which the measurement parameter (2) is varied, is selected to be smaller in a range around the target value (31) of the measurement variable (3) and larger in the vicinity of an upper limit (34) and lower limit (33) of the fluctuation range (32) for the measurement variable (3).

8. The method (1000) according to claim 1, wherein the variation range (21) for the measurement parameter (2) is determined based on a technical specification of the measurement process, a device used for the measurement process, and/or the test object (3).

9. The method (1000) according to claim 5, wherein the target value (31) of the measurement variable (3), the fluctuation range (32) for the measurement variable (3), the known correlation (5) between the measurement variable (3) and the measurement parameter (2), and/or the technical specification, are obtained from at least one data sheet (6) and/or digitally stored data record of the measurement process, of a device used for the measurement process, and/or of the test object (1).

10. The method (1000) according to claim 1, wherein at least one specimen of a component is selected as the test object (1).

11. The method (1000) according to claim 10, wherein a fuel injector for an engine is selected as a test object (1).

12. The method (1000) according to claim 1, wherein, in response to the determined repeatability variance satisfying a predefined criterion, it is determined that the measurement process is suitable for quality control of series production.

13. The method (1000) according to claim 1, wherein the measurement variable (3) comprises an injection quantity of a liquid, a supply quantity of a gas, an output power, a current, and/or a torque.

14. The method (1000) according to claim 1, wherein the measurement parameter (2) comprises a pressure, an injection time, a feed time, an electrical voltage, and/or a temperature.

15. (canceled)

16. A non-transitory, computer-readable medium containing instructions that when executed by a computer cause the computer to determine the repeatability variance of a given measurement process to be carried out on a test object (1), by:
determining (200) at least one measurement parameter (2) of the measurement process, on which measurement parameter the result of the measurement process also depends, in addition to the properties of the test object (1), which properties are to be measured and are provided in the form of a measurement variable (3) to be considered;
determining a variation range (21) for the at least one measurement parameter (2);
carrying out (300) a plurality of measurements on the test object (1) for various values (210, 211, 212) of the at least one measurement parameter (2) within the relevant variation range (21), so that at least one distribution (310, 311, 312) of the measured values of the measurement variable (3) is obtained with at least one measure of dispersion (310a, 311a, 312a); and
analyzing the sought-after repeatability variance from the at least one measure of dispersion (310a, 311a, 312a) of the at least one distribution (310, 311, 312) of the measured values obtained.

17. (canceled)

18. The method (1000) according to claim 1, further comprising implementing the measurement process in production quality control during manufacturing of a component.
